(19) United States
(12) Patent Application Publication
(10) Pub. No.: US 2026/0145743 A1
(43) Pub. Date: May 28, 2026

(54) ROCKER ASSEMBLY FOR VEHICLE BODY INTEGRITY AND MAXIMIZING HIGH VOLTAGE COMPONENT PACKAGING SPACE

(71) Applicant: FCA US LLC, Auburn Hills, MI (US)

(72) Inventors: Santosh Pethe, Auburn Hills, MI (US); Eric Stahmer, Auburn Hills, MI (US); Kedar Panday, Auburn Hills, MI (US); Scott McGuire, Auburn Hills, MI (US)

(21) Appl. No.: 18/960,586

(22) Filed: Nov. 26, 2024

(51) Int. Cl. B62D 25/02

(52) U.S. Cl. CPC B62D 25/025

(57) ABSTRACT

A rocker assembly for an electrified vehicle includes a rocker panel, an extrusion and a fastener assembly. The rocker panel defines a plurality of first apertures. The extrusion defines a plurality of second apertures. The fastener assembly includes a first fastener assembly having a first fastener receiving member and a first fastener insertion member. A first aperture of the plurality of first apertures in the rocker panel receives the first fastener insertion member. A first aperture of the plurality of second apertures in the extrusion receives the first fastener receiving member. The first fastener insertion member and the first fastener receiving member threadably mate in an assembled position thereby coupling the extrusion and the rocker panel together.

### FIELD

The present application relates generally to rocker assemblies in electrified vehicles and, more particularly, to a rocker assembly that optimizes body integrity and maximizes high voltage component packaging space.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An electrified vehicle (hybrid electric, plug-in hybrid electric, range-extended electric, battery electric, etc.) includes at least one battery system and at least one electric motor. Typically, the electrified vehicle would include a high voltage component or battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor. Typically the high voltage battery system is housed in the lower frame of the electrified vehicle. Ensuring structural integrity at the hinge pillar, rocker panel and A-pillar areas of the vehicle body is crucial for achieving structural integrity and a good safety rating.

### SUMMARY

In accordance with one example aspect of the invention, a rocker assembly for an electrified vehicle includes a rocker panel, an extrusion and a fastener assembly. The rocker panel defines a plurality of first apertures. The extrusion defines a plurality of second apertures. The fastener assembly includes a first fastener assembly having a first fastener receiving member and a first fastener insertion member. A first aperture of the plurality of first apertures in the rocker panel receives the first fastener insertion member. A first aperture of the plurality of second apertures in the extrusion receives the first fastener receiving member. The first fastener insertion member and the first fastener receiving member threadably mate in an assembled position thereby coupling the extrusion and the rocker panel together.

In addition to the foregoing, the fastener assembly further comprises a second fastener assembly having a second fastener receiving member and a second fastener insertion member. A second aperture of the plurality of first apertures in the rocker panel receives the second fastener insertion member. A second aperture of the plurality of second apertures in the extrusion receives the second fastener receiving member. The second fastener insertion member and the second fastener receiving member threadably mate in the assembled position thereby coupling the extrusion and the rocker panel together.

In addition to the foregoing, the fastener assembly further comprises a third fastener assembly having a third fastener receiving member and a third fastener insertion member. A third aperture of the plurality of first apertures in the rocker panel receives the third fastener insertion member. A third aperture of the plurality of second apertures in the extrusion receives the third fastener receiving member. The third fastener insertion member and the third fastener receiving member threadably mate in the assembled position thereby coupling the extrusion and the rocker panel together.

In addition to the foregoing, the fastener assembly further comprises a fourth fastener assembly having a fourth fastener receiving member and a fourth fastener insertion member. A fourth aperture of the plurality of first apertures in the rocker panel receives the fourth fastener insertion member. A fourth aperture of the plurality of second apertures in the extrusion receives the fourth fastener receiving member. The fourth fastener insertion member and the fourth fastener receiving member threadably mate in the assembled position thereby coupling the extrusion and the rocker panel together.

In addition to the foregoing, the first fastener receiving member comprises a first pipe nut.

In other examples, the first fastener insertion member comprises a first bolt.

In addition to the foregoing, the fastener assembly further comprises a washer that locates between the first bolt and the rocker panel.

In examples, the extrusion is formed of aluminum.

In other examples, the rocker panel is formed of steel.

In some implementations, the fastener assembly extends along an axis transverse to the extrusion.

In other examples, the first fastener assembly is located within one-fifth of a total length of the extrusion toward a front end of the extrusion.

In further examples, the fourth fastener assembly is located within one-fifth of a total length of the extrusion toward a rear end of the extrusion.

In some examples, the second and third fastener assemblies are located within a middle one-third of a total length of the extrusion.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

The present disclosure will become more fully understood from the detailed description and the accompanying drawings, given purely by way of non-limiting example, wherein:

FIG. 1 is a side view of an electrified vehicle frame that incorporates a rocker assembly having a rocker panel, an extrusion and a fastener assembly arrangement according to the principles of the present disclosure;

FIG. 2 is a perspective view of the rocker assembly of FIG. 1 according to an example of the present disclosure;

FIG. 3 is an exploded perspective assembly view of the rocker assembly of FIG. 2 according to the principles of the present disclosure; and

FIG. 4 is a cross-sectional view of the rocker assembly taken along lines 4-4 of FIG. 1 according to the principles of the present disclosure.

### DESCRIPTION

As previously discussed, in electrified vehicles, a high voltage battery system is utilized to power at least one electric motor configured on the vehicle and to recharge the low voltage battery system via a direct current to direct current (DC-DC) convertor. Typically, the high voltage battery system is housed in the lower frame of the electrified vehicle. Ensuring structural integrity at the hinge pillar, rocker panel and A-pillar areas of the vehicle body is crucial for achieving structural integrity and a good safety rating. In instances of a vehicle front crash event, a front wheel of the vehicle can be driven toward and into the rocker panel. The impact of the wheel onto the rocker panel can experience significant loading (such as, but not limited to, 600 kN) which can cause significant sheet metal spot weld openings and damage to the hinge pillar.

In some previous attempts at reinforcing the rocker panel, doublers, bolts and reinforcements can be added to the hinge panel area of the vehicle. Additionally, shear plates have been attached to the rocker extrusion. However, such configurations require undesirable increases in part count, increase in vehicle weight, increase in vehicle cost and adding to the manufacturing process complexity. The present disclosure provides a rocker assembly that can endure high loads, reduce complexity and optimize packaging space available to the high voltage battery.

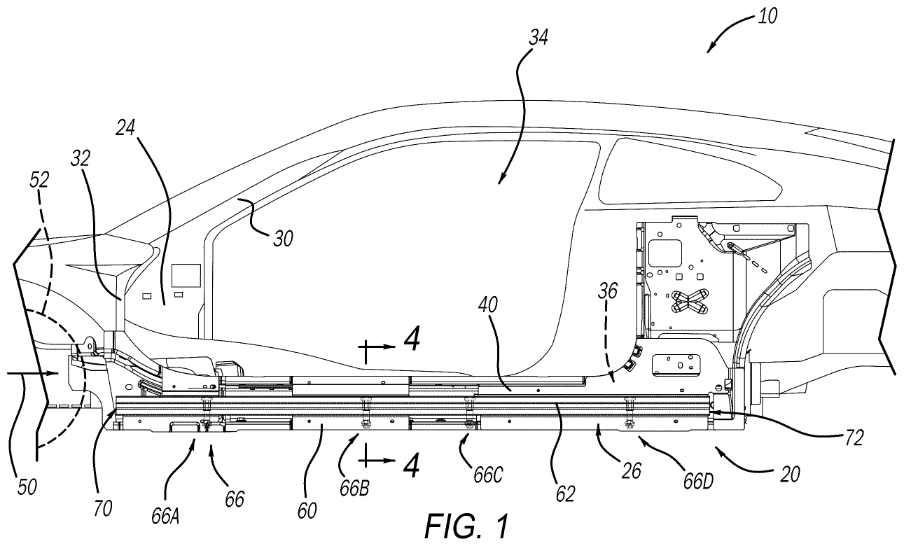

Referring now to FIG. 1, an electrified vehicle 10 that incorporates a rocker assembly 20 constructed in accordance to the present disclosure is shown. The electrified vehicle 10 generally includes a vehicle body 24 having a vehicle frame 26. The vehicle frame 26 generally includes an A-pillar 30, and a hinge pillar 32. The vehicle frame 26 further defines a passenger compartment 34 and high voltage battery compartment 36 that houses a high voltage battery 40. As will become appreciated herein, the rocker assembly 20 improves body integrity of the electrified vehicle 10 and maximizes packaging space (e.g., at the high voltage battery compartment 36) for the high voltage battery 40. In the particular example described herein, the rocker assembly 20 can endure a high impact load 50 such as a crash load transferred at least in part from a vehicle wheel 52.

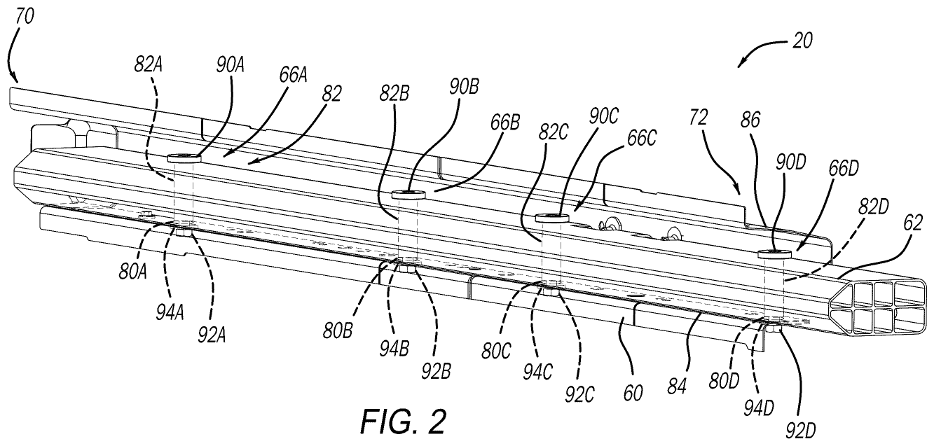

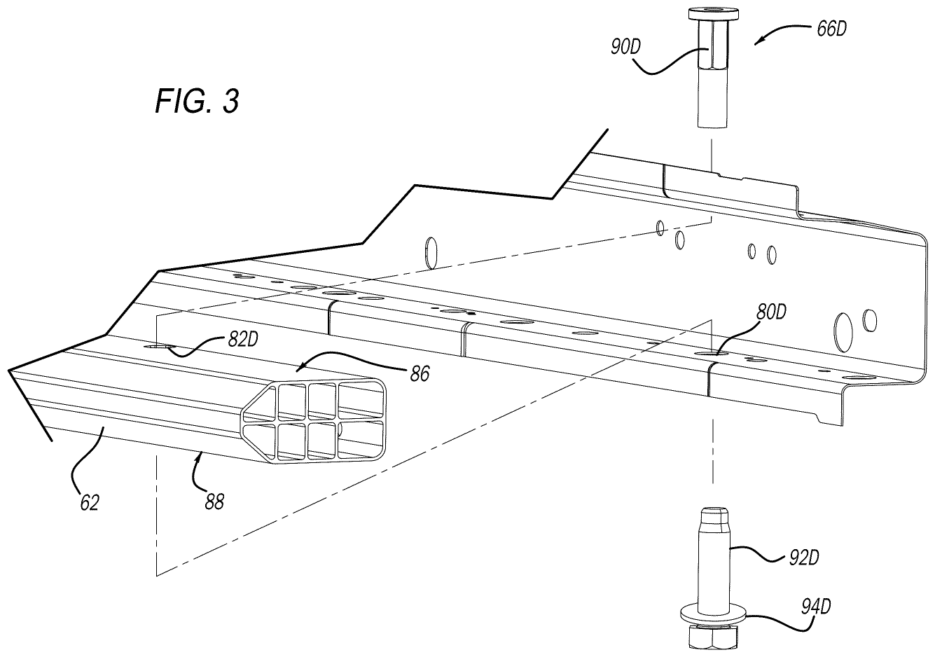

With continued reference to FIG. 1 and additional reference to FIGS. 2-4 , the rocker assembly 20 will be further described. The rocker assembly 20 generally includes a rocker panel 60, an extrusion 62 and a fastener assembly collectively identified at 66. The rocker panel 60 is formed of a rigid material such as steel. The extrusion 62 is formed of a lightweight rigid material such as aluminum. The exemplary fastener assembly 66 includes a first fastener assembly 66A, a second fastener assembly 66B, a third fastener assembly 66C and a fourth fastener assembly 66D. The rocker panel 60 generally extends between a front rocker end 70 and a rear rocker end 72. The rocker panel 60 defines a plurality of first apertures, collectively identified at 80. The first apertures 80 are generally defined through a lower flange 84 of the rocker panel 60. The extrusion 62 defines a plurality of second apertures, collectively identified at 82. The second apertures 82 are generally defined entirely through the extrusion 62 from an upper surface 86 to a lower surface 88.

The first fastener assembly 66A generally includes a first fastener receiving member or pipe nut 90A, a first fastener insertion member or bolt 92A, and a first washer 94A. The second fastener assembly 66B generally includes a second fastener receiving member or pipe nut 90B, a second fastener insertion member or bolt 92B, and a second washer 94B. The third fastener assembly 66C generally includes a third fastener receiving member or pipe nut 90C, a third fastener insertion member or bolt 92C, and a third washer 94C. The fourth fastener assembly 66D generally includes a fourth fastener receiving member or pipe nut 90D, a fourth fastener insertion member or bolt 92D, and a fourth washer 94D.

The plurality of first apertures 80 in the rocker panel 60 further include a first aperture 80A configured to receive the first fastener insertion member 92A of the first fastener assembly 66A; a second aperture 80B configured to receive the second fastener insertion member 92B of the second fastener assembly 66B; a third aperture 80C configured to receive the third fastener insertion member 92C of the third fastener assembly 66C; and a fourth aperture 80D configured to receive the fourth fastener insertion member 92D of the fourth fastener assembly 66D.

The plurality of second apertures 82 in the extrusion 62 further include a first aperture 82A configured to receive the first fastener insertion member 92A of the first fastener assembly 66A; a second aperture 82B configured to receive the second fastener insertion member 92B of the second fastener assembly 66B; a third aperture 82C configured to receive the third fastener insertion member 92C of the third fastener assembly 66C; and a fourth aperture 82D configured to receive the fourth fastener insertion member 92D of the fourth fastener assembly 66D. In the assembled position, the first through fourth fastener insertion members 92A-92D can threadably mate with the corresponding first through fourth fastener receiving members 90A-90D.

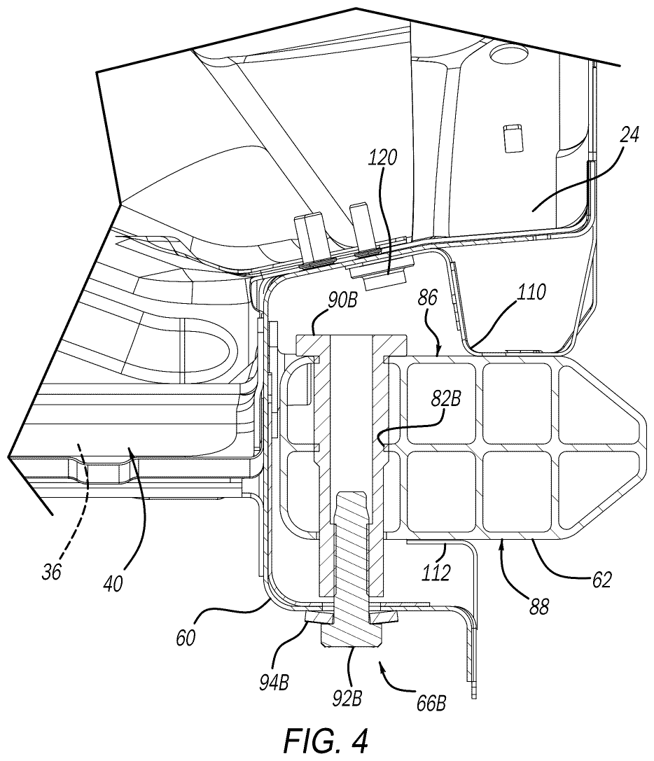

With particular reference to FIG. 4, the rocker panel 60 can further include an upper rocker support arm 110 and a lower rocker support arm 112 that generally support the extrusion 62. In the example shown, the upper rocker support arm 110 supports the extrusion 62 at the upper surface 86 while the lower rocker support arm 112 supports the extrusion 62 at the lower surface 88. Fastening members 120 can also be incorporated generally couple the rocker panel 60 to the vehicle body 24. Other configurations are contemplated.

The rocker assembly 20 disclosed herein provides many advantages such as described above. Further, fastener assembly 66 of the rocker assembly 20 helps reduce rocker spot-weld areas by engaging the aluminum extrusion 62 in the load path (e.g., see load 50, FIG. 1) which stabilizes the hinge pillar 32 and passenger compartment 34 area intrusion. The configuration and placement of the fastener assemblies 60 was selected based on studies conducted on variations in kinematics load of the wheel 52 focusing on various intensities of load experienced by the rocker 60. Based on the variation studies, the components and placement relative to the rocker 60 and extrusion 62 have been determined that ensure the integrity of the rocker assembly 20 under potential high load impact events. For example, the first fastener assembly 66A is located within one-fifth of a total length of the extrusion 62 toward a front end 70 of the extrusion 62. Similarly, the fourth fastener assembly 66D is located within one-fifth of a total length of the extrusion 62 toward the rear end 72 of the extrusion 62. In additional implementations, the second and third fastener assemblies 66B and 66C are located within a middle one-third of a total length of the extrusion 62.

The fastener assemblies 66A-66D are inserted generally vertically (or transverse to a longitudinal axis of the extrusion 62) thereby optimizing packaging space of the high voltage battery 40 in the battery compartment 36. Moreover, hard contact points between the fastener assemblies 66 and the high voltage battery 40 are eliminated during a side impact event. In examples, the fastener assemblies 66 help reduce mass as compared to previous solutions. By way of non-limiting example, the mass of the fastener assemblies 66 is about eight pounds lighter than previous solutions.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

What is claimed is:

1. A rocker assembly for an electrified vehicle, the rocker assembly comprising:
a rocker panel that defines a plurality of first apertures;
an extrusion that defines a plurality of second apertures; and
a fastener assembly comprising:
a first fastener assembly having a first fastener receiving member; and
a first fastener insertion member;
wherein a first aperture of the plurality of first apertures in the rocker panel receives the first fastener insertion member and a first aperture of the plurality of second apertures in the extrusion receives the first fastener receiving member, wherein the first fastener insertion member and the first fastener receiving member threadably mate in an assembled position thereby coupling the extrusion and the rocker panel together.

2. The rocker assembly of claim 1, wherein the fastener assembly further comprises:
a second fastener assembly having a second fastener receiving member and a second fastener insertion member, wherein a second aperture of the plurality of first apertures in the rocker panel receives the second fastener insertion member and a second aperture of the plurality of second apertures in the extrusion receives the second fastener receiving member, wherein the second fastener insertion member and the second fastener receiving member threadably mate in the assembled position thereby coupling the extrusion and the rocker panel together.

3. The rocker assembly of claim 2, wherein the fastener assembly further comprises:
a third fastener assembly having a third fastener receiving member and a third fastener insertion member, wherein a third aperture of the plurality of first apertures in the rocker panel receives the third fastener insertion member and a third aperture of the plurality of second apertures in the extrusion receives the third fastener receiving member, wherein the third fastener insertion member and the third fastener receiving member threadably mate in the assembled position thereby coupling the extrusion and the rocker panel together.

4. The rocker assembly of claim 3, wherein the fastener assembly further comprises:
a fourth fastener assembly having a fourth fastener receiving member and a fourth fastener insertion member, wherein a fourth aperture of the plurality of first apertures in the rocker panel receives the fourth fastener insertion member and a fourth aperture of the plurality of second apertures in the extrusion receives the fourth fastener receiving member, wherein the fourth fastener insertion member and the fourth fastener receiving member threadably mate in the assembled position thereby coupling the extrusion and the rocker panel together.

5. The rocker assembly of claim 1, wherein the first fastener receiving member comprises a first pipe nut.

6. The rocker assembly of claim 5, wherein the first fastener insertion member comprises a first bolt.

7. The rocker assembly of claim 6, wherein the fastener assembly further comprises a washer that locates between the first bolt and the rocker panel.

8. The rocker assembly of claim 1, wherein the extrusion is formed of aluminum.

9. The rocker assembly of claim 8, wherein the rocker panel is formed of steel.

10. The rocker assembly of claim 1, wherein the fastener assembly extends along an axis transverse to the extrusion.

11. The rocker assembly of claim 4, wherein the first fastener assembly is located within one-fifth of a total length of the extrusion toward a front end of the extrusion.

12. The rocker assembly of claim 11, wherein the fourth fastener assembly is located within one-fifth of a total length of the extrusion toward a rear end of the extrusion.

13. The rocker assembly of claim 12, wherein the second and third fastener assemblies are located within a middle one-third of a total length of the extrusion.
